(19) United States
(12) Patent Application Publication
(10) Pub. No.: US 2018/0279628 A1
(43) Pub. Date: Oct. 4, 2018

(54) Vegetable-Based Food Product

(71) Applicants: Daniel Routson, Hanover, PA (US); Kimberley Ann Routson, Hanover, PA (US)

(72) Inventors: Daniel Routson, Hanover, PA (US); Kimberley Ann Routson, Hanover, PA (US)

(21) Appl. No.: 15/689,868

(22) Filed: Aug. 29, 2017

Related U.S. Application Data
(60) Provisional application No. 62/480,645, filed on Apr. 3, 2017.

(51) Int. Cl. A21D 2/36; A21D 2/18; A21D 2/26

(52) U.S. Cl. CPC A21D 2/36; A21D 2/266; A21D 2/186

(57) ABSTRACT

A food product composition is provided and includes a a dry mix composition in an amount of from about 15.50 to about 30.00 weight percentage (wt %) of the food product composition and having a gluten free flour, water in an amount of from about 16.00 to about 20.00 wt % of the food product composition, a leavening agent in an amount from about 0.20 to about 0.30 wt % of the food product composition, a protein source in an amount from about 0.50 to about 19.00 wt % of the food product composition, a gluten free substitute in an amount from about 45.00 to about 72.00 wt % of the food product composition and having cauliflower; and a remainder of the composition containing a balance of incidental ingredients in an amount that is about 2.00 wt % or less of the food product composition.

### FIELD OF THE INVENTION

The field of the invention is directed to a food product and, more particularly, is directed to a vegetable-based food product used for dough having a low gluten content and a low-glycemic-index, and to a method to prepare the food product.

### BACKGROUND

Doughs and food products from doughs are typically made from grains (for example, wheat, barley, rye) containing carbohydrates and gluten protein. Wheat has become a staple food product in the modern Western diet. However, many people are affected negatively by ingesting carbohydrates and gluten, including diabetics and those diagnosed with celiac disease, respectively. As a result, the consumption of even the smallest amounts of carbohydrates and gluten may cause adverse effects.

When people with celiac disease eat gluten, their body mounts an immune response that attacks the small intestine. These attacks lead to damage on the villi, small fingerlike projections that line the small intestine, that promote nutrient absorption. When the villi get damaged, nutrients cannot be absorbed properly into the body. For a person with celiac disease, often the only treatment is a life-long, gluten-free diet.

When a diabetic eats foods high in carbohydrates, their blood sugar can rise to very high levels. Therefore, it is important that a diabetic avoid foods high in simple carbohydrates.

Typically gluten-free food products are based on a single ingredient substituted for the gluten-containing wheat such as rice or maize. Not only are these food products often unpalatable, but the grains used generally have an undesirably high glycemic index (GI), which indicates the speed at which carbohydrates are absorbed into the blood stream. The higher the index is, the faster the carbohydrate absorption occurs and consequently the faster negative affects occur on a diabetic's insulin absorption. (revise explanation on basic insulin physiology?)

There is a need in the food industry for a food product that tastes good but eliminates or reduces gluten and has a low glycemic index effect on the person who consumes the food product. Some known food products substitute cauliflower as a major overall additive to lower the carbohydrate and calorie intake of normal foods. However, typical food products, such as dough, that use cauliflower are brittle, dry, unpalatable, or unsavory.

Accordingly, a non-wheat-based food product is provided that is savory, palatable, and has a low-glycemic-index.

### SUMMARY

A food product composition is provided and includes a a dry mix composition in an amount of from about 15.50 to about 30.00 weight percentage (wt %) of the food product composition and having a gluten free flour, water in an amount of from about 16.00 to about 20.00 wt % of the food product composition, a leavening agent in an amount from about 0.20 to about 0.30 wt % of the food product composition, a protein source in an amount from about 0.50 to about 19.00 wt % of the food product composition, a gluten free substitute in an amount from about 45.00 to about 72.00 wt % of the food product composition and having cauliflower; and a remainder of the composition containing a balance of incidental ingredients in an amount that is about 2.00 wt % or less of the food product composition.

### DETAILED DESCRIPTION OF THE EMBODIMENT(S)

The present invention provides an edible, vegetable-based dough-like food product and a process for its preparation.

The claimed invention is a food product for use in pizza and related products that does not contain gluten. More particularly, invention incorporates cauliflower (Brassica oleracea var. Botrytis), a non-gluten-containing vegetable, and eliminates wheat from the composition. This composition accomplishes two desirable goals: 1) it eliminates gluten-containing wheat, and 2) it lowers the overall carbohydrate content of the food product. These adjustments produce a food product suitable for use as a pizza dough, focaccia bread, flatbread, or chip that approximates the texture, flavor, mouth feel, and structure of a traditional wheat flour-containing dough and helps sensitive individuals avoid triggering celiac disease or a diabetic response.

The food product according to the invention is a mixture of cauliflower, a dry mix of gluten free starches, a protein source, a food grade reducing agent, a leavening agent, and water form the basis of a dough that is augmented with components such as flavoring (including spices) and toppings.

The end product of this composition is a food product that can be used as a base for a pizza, focaccia bread, chips, and flatbread. The composition yields a food product that is an acceptable substitute for a traditional wheat-based pizza dough with regards to mouth feel, texture, flavor, and other organoleptic properties. This food product composition uses ingredients that will create a gluten-free final product. This food product composition can have lower overall carbohydrate content and a lower overall caloric content when compared to regular wheat flour containing dough mixtures. This food product composition can have low-glycemic index effects for those for who diets to control for this variable are desirable. This food product composition can be sold as refrigerated or frozen dough in whole or as part of, but not limited to, frozen pizza, focaccia bread, and breadsticks, regular breads, and the like. This food product composition can be baked or fried for use in whole or as part of, but not limited to, crackers, chips, wafers, and croutons.

Gluten Free Substitute

According to the invention, cauliflower (Brassica oleracea var. Botrytis) florets of a white headed form are preferred as the non-gluten-containing component of the food product. Other cauliflower botrytis varieties may be used and remain within the scope of the invention. One hundred grams of raw white cauliflower provides 25 calories, and is lower in fat, carbohydrates, and protein than an equivalent measure of white wheat flour. The non-gluten-containing component, such as raw cauliflower florets, are prepared by chopping, grating, finely shredding, ricing, or similar process to obtain a desirable texture or sized particle.

For purposes of defining the invention, ricing meant to pass a food through a food mill or “ricer”, which comes in several forms. In the most basic, food is pushed or pressured through a metal or plastic plate with many small holes, producing a smoother result than mashing, but coarser than pureeing or passing through a sieve or tamis. The size of the product produced by ricing is about the same as grains of rice. According to the invention, fried non-gluten-containing component is sized at approximately 500-2500μ. Approximately, 1 cup of riced, drained cauliflower, 500-2500μ, is 3.7 oz. Whereas, 1 cup of riced, undrained cauliflower that is sized from 500-2500μ is 5.0 oz. If the cauliflower is not riced, then 1 cup of chunky, undrained cauliflower, which is sized from 500μ or larger, is approximately 4.0 oz.

Dry Mix

A dry mix of gluten free starches is also provided and may include, but is not limited to, brown rice flour, coconut flour, potato starch, tapioca starch, pea fiber, rice flour, xanthan gum, guar gum, and almond flour.

Protein Source

The food product further includes at least one protein source. Preferably, the protein source is from an egg product or substitute egg product. The protein source may also be from soy, whey or whey components, and are obtained from eggs, milk, flaxseed, and soy sources. Different cheeses could be used as well, including goat cheese and mozzarella.

Leavening Agent

A leavening agent is included in the food product composition to influence the texture of the cooked food product composition. Preferably, the leavening agent is an active yeast. Alternatively, the leavening agent may be a chemical agent such as sodium bicarbonate, sodium aluminum phosphate, mono-calcium phosphate, and other such agents known to those of ordinary skill in the art.

Water:

Water is used to adequately to activate yeast. Preferably, water should be about 90° F. to about 120° F.

Spices and Flavorings

Any of the following spices can be added to the food product composition base to alter the flavor as needed: allspice, basil, bay leaves, caraway seeds, cardamom, cayenne, celery, chives, chili powder, chives, cilantro, cinnamon, cloves, coriander, cumin, curry powder, dill weed, fennel seed, garlic, ginger, ginseng, mace, marjoram, mint, mustard, nutmeg, onion, oregano, paprika, parsley, peppercorns, red pepper, rosemary, saffron, sage, salt, sesame seed, tarragon, thyme, and turmeric. Additionally, flavorings may be added and these include . . . .

Nutritional Additives

Niacin, iron, thiamine mononitrate, riboflavin, folic acid, sodium chloride, and the like may be added to the composition.

Additional Ingredients

In addition to the compositional elements listed above, other ingredients known to those of ordinary skill in the art can be included in the food product composition to provide further desirable characteristics, such as flavor, texture, and such organoleptic properties such as mouth feel, doughiness, and the like.

For example, a food grade reducing agent may be included in the food product composition to influence the product's texture and other characteristics.

Altering the weight percent of cauliflower suits the food product composition for particular applications as will be set out below.

TABLE 1
Food Product Composition

| | Range (% by weight of total composition) | | |
|---|---|---|---|
| Ingredient | Embodiment 1: | Embodiment 2: | Embodiment 3: |
| Dry Mix - gluten-free | 15.50-21.50 | 18.00-21.00 | 16.00-19.00 |
| flour | | | |
| Water | 16.00-20.00 | 18.00-20.00 | 16.00-18.50 |
| Leavening agent | 0.20-0.30 | 0.24-0.27 | 0.21-0.25 |
| Protein source | 0.50-19.00 | 0.50-2.00 | 15.00-19.00 |
| Gluten free | 45.00-72 | 55.00-72 | 50.00-55.00 |
| substitute - | | | |
| Cauliflower | | | |
| Additional Ingredients | <2.0 | <2.0 | <2.0 |

Table 1 shows weight percentage ranges of several embodiments of a food product according to the invention.

TABLE 2
Food Product Composition

Range (% by weight of
total composition)

| | Embodiment 4: | Embodiment 5: |
|---|---|---|
| Ingredient | (Pizza/Focaccia) | (Pizza/Focaccia) |
| Dry mix of gluten free | 20.26 | 18.78 |
| starches | | |
| Water | 19.74 | 18.29 |
| Leavening agent | 0.26 | 0.24 |
| Protein source (Flax) | 1.32 | N/A |
| Protein source (Egg) | N/A | 18.29 |
| Gluten free substitute - | 58.42 | 54.15 |
| Cauliflower | | |
| Additional Ingredients | <2.0 | <2.0 |

Table 2 shows weight percentage ranges of additional embodiments of a food product according to the invention, whereby flax is used as the protein source.

TABLE 3
Food Product Composition

Range (% by weight of
total composition)

| | Embodiment 6: | Embodiment 7: |
|---|---|---|
| Ingredient | (Chip/Cracker) | (Chip/Cracker) |
| Dry mix of gluten free | 19.35 | 16.63 |
| starches | | |
| Water | 18.84 | 16.2 |
| Leavening agent | 0.25 | 0.22 |
| Protein source (Flax) | 1.26 | N/A |
| Protein source (Egg) | N/A | 15.12 |
| Gluten free substitute - | 60.3 | 51.84 |
| Cauliflower | | |
| Additional Ingredients | <2.0 | <2.0 |

Table 3 shows weight percentage ranges of additional embodiments of a food product according to the invention, whereby egg is used as the protein source.

In an exemplary embodiment of the invention, the dry mix includes the following ingredients by measurement:

2.2 oz Brown Rice Flour

0.9 oz Coconut Flour

0.75 oz Potato Starch

A total of 3.85 oz of Dry Mix

In an exemplary embodiment of the invention, the dry mix composition by weight percentage will change based on the protein source selected and the function of the food product.

Generally, the weight percentage of the dry mix is about 16.00 to about 21.00 wt % of the total food product composition. However, if flax seed is used as the protein source, the weight percentage of the dry mix is about 19.00 to about 21.00 wt % of total food product composition. If egg is used as a protein source, the weight percentage of the dry mix is about 16.00 to about 19.00 wt % of total food product composition.

In an exemplary embodiment, whereby the food product is used as a dough for a pizza or focaccia, the weight percentage of dry mix is about 18.00 to about 21.00 wt % of the total food product composition. However, in an exemplary embodiment, whereby the food product is used as dough for a chip or cracker, the weight percentage of dry mix is about 16.00 to about 20 wt % of the total food product composition.

In an exemplary embodiment of the invention, active yeast is used as a leveaning agent. More particularly, in an exemplary embodiment of the invention, approximately 0.05 oz of active yeast is used for 3.85 oz of dry mix.

In an exemplary embodiment of the invention, the yeast composition by weight percentage will change based on the protein source selected and the function of the food product.

Generally, the weight percentage of the yeast is about 0.20 to about 0.30 wt % of the total food product composition. However, if flax seed is used as the protein source, the weight percentage of the active yeast is about 0.24 to about 0.27 wt % of total food product composition. If egg is used as a protein source, the weight percentage of the active yeast is about 0.21 to about 0.25 wt % of total food product composition.

In an exemplary embodiment, whereby the food product is used as a dough for a pizza or focaccia, the weight percentage of active yeast is about 0.23 to about 0.27 wt % of the total food product composition. However, in an exemplary embodiment, whereby the food product is used as dough for a chip or cracker, the weight percentage of dry mix is about 0.21 to about 0.26 wt % of the total food product composition.

In an exemplary embodiment of the invention, water is combined with the leavening agent and the dry mix. More particularly, in an exemplary embodiment of the invention, approximately 3.75 oz of water is combined with 0.05 oz of active yeast and 3.85 oz of dry mix.

In an exemplary embodiment of the invention, the composition weight percentage of water will change based on the protein source selected and the function of the food product.

Generally, the weight percentage of water is about 16.00 to about 20.00 wt % of the total food product composition. However, if flax seed is used as the protein source, the weight percentage of water is about 18.00 to about 20.00 wt % of total food product composition. If egg is used as a protein source, the weight percentage of water is about 16.00 to about 18.50 wt % of total food product composition.

In an exemplary embodiment, whereby the food product is used as a dough for a pizza or focaccia, the weight percentage of water is about 18.00 to about 20.00 wt % of the total food product composition. However, in an exemplary embodiment, whereby the food product is used as dough for a chip or cracker, the weight percentage of water is about 16.00 to about 19.00 wt % of the total food product composition.

The food product according to the invention further includes a protein source. In an exemplary embodiment of the invention, the protein source is flax seed or egg(s) depending on what the food product is being used for. The protein source is combined with the leavening agent, the dry mix, and the water. More particularly, in an exemplary embodiment of the invention, approximately 0.25 oz of flax seed can be substituted for eggs entirely, or 1 egg (approximately 1.75 oz) is used for pizza or focaccia dough and 3 eggs (approximately 3.5 oz) is used for a chip or cracker dough.

Generally, the weight percentage of the protein source is about 12.00 to about 19.00 wt % of the total food product composition. However, if flax seed is used as the protein source, the weight percentage of the protein source is about 12.00 to about 14.00 wt % of total food product composition. If egg is used as a protein source, the weight percentage of the protein source is about 15.00 to about 19.00 wt % of total food product composition.

In an exemplary embodiment, whereby the food product is used as a dough for a pizza or focaccia, the weight percentage of the protein source is about 13.00 to about 18.50 wt % of the total food product composition. However, in an exemplary embodiment, whereby the food product is used as dough for a chip or cracker, the weight percentage of water is about 12.00 to about 15.50 wt % of the total food product composition.

The food product according to the invention further includes a non-gluten substitute. In an exemplary embodiment of the invention, the non-gluten substitute is cauliflower.

The food product will utilize the same ingredients, as described above, whether used as a pizza or bread dough embodiment or as chip or cracker embodiment. However, the difference between exemplary embodiments is the preferable size of the chopped cauliflower, as this alters the texture and density of the final product composition. For example, 3 cups of riced, drained cauliflower, sized from 500-2500μ (3.7 oz) may be used for pizza and focaccia dough, while 3 cups of chunky, undrained of cauliflower, sized from 500μ or larger, (4.0 oz) may be used. Although draining of the cauliflower is not required, it can provide a more desirable outcome while baking.

Generally, the weight percentage of cauliflower is about 45.00 to about 65.00 wt % of the total food product composition. However, if flax seed is used as the protein source, the weight percentage of cauliflower is about 55.00 to about 62.00 wt % of total food product composition. If egg is used as a protein source, the weight percentage of cauliflower is about 50.00 to about 55.00 wt % of total food product composition.

In an exemplary embodiment, whereby the food product is used as a dough for a pizza or focaccia, the weight percentage of cauliflower is about 54.00 to about 58.50 wt % of the total food product composition. However, in an exemplary embodiment, whereby the food product is used as dough for a chip or cracker, the weight percentage of cauliflower is about 51.00 to about 60.50 wt % of the total food product composition.

In an exemplary embodiment of the invention, the food product includes fresh cauliflower florets and then processed by chopping, finely grating, shredding, ricing, or similarly treating the vegetable and set aside for mixture at a later time. The particular method for reducing the particle size of the cauliflower florets is chosen to produce a desired texture in the resulting food product and final food product.

After processing, the cauliflower can be strained/drained to remove excess water that can cause variances in the desired outcome of the final mixed product. The florets can have a range of water densities based on their internal volume of water. The extent to which water will be drained from the processed cauliflower will be determined by one of ordinary skill in the art to produce a particular desired texture in the resulting food product and the final product.

Now, an exemplary preparation of the food product according to the invention will be described. The exemplary embodiment is directed to a food product for substitute pizza or focaccia bread dough.

In a mixing container, thoroughly mix the dry mix ingredients with a protein source to form Mixture 1a.

Next, a first portion of Mixture 1a is placed into a separate mixing container and combined with the yeast and the water at 90-120° F. to Mixture 1b. Mixture 1b should sit for 25-30 minutes at a temperature above 65° F., as this allows for the proper activation of the yeast. After fermentation, the remained of Mixture 1a is added with Mixture 1b to form Mixture 1c. At this point, the food product base is ready to be mixed with the previously chopped/grated/shredded/or riced cauliflower.

Next, Mixture 1c is combined with processed cauliflower to form Mixture 1d, which will become the base. Various spices can be added to Mixture 1d to achieve the desired taste. These include, but are not limited to, allspice, basil, bay leaves, caraway seeds, cardamom, cayenne, celery, chives, chili powder, chives, cilantro, cinnamon, cloves, coriander, cumin, curry powder, dill weed, fennel seed, garlic, ginger, ginseng, mace, marjoram, mint, mustard, nutmeg, onion, oregano, paprika, parsley, peppercorns, red pepper, rosemary, saffron, sage, salt, sesame seed, tarragon, thyme, and turmeric.

Mixture 1d and any various spices will be thoroughly mixed together to create the final food product (Mixture 1e) used in the exemplary embodiment as a substitute for a pizza dough, crust, or focaccia bread dough.

Next, an oven is preheated to 400° Fahrenheit. A convection-type oven, induction cooking devices and other non-traditional ovens can be utilized at temperatures and baking times as determined by those of ordinary skill in the art for a desired outcome.

Mixture 1e is shaped into desired form (round, square, rectangle, etc.) while maintaining 1/16th to ¼th inch thickness. The chosen thickness will effect cooking times and desired final thickness, as the use of a thicker food product will change the density and elasticity of the final product. Cooking surfaces suitable for baking (rack, metal, stone, or other solid surfaces) can affect the final product. The use of a parchment-type paper can be utilized to release water from the mixture during baking.

After shaping the food product into a desired form and placing it onto the chosen cooking surface, bake the Mixture 1e food product in the preheated oven for approximately 30 minutes. After approximately 30 minutes, flip the food product horizontally and cook for an additional 5-15 minutes until brown.

At this point, the food product is ready for any toppings that are desired, including, but not limited to, seafood, fruit, tomato sauce, barbecue sauce, shredded cheeses, pepperoni, sausage, bacon, ham, turkey, chicken, beef, broccoli, onion, peppers, mushrooms, olives, tomatoes, artichokes, spinach, kale, pesto, and the like.

Various additional herbs and spices can be added to the topping, including but not limited to, allspice, basil, bay leaves, caraway seeds, cardamom, cayenne, celery, chives, chili powder, chives, cilantro, cinnamon, cloves, coriander, cumin, curry powder, dill weed, fennel seed, garlic, ginger, ginseng, mace, marjoram, mint, mustard, nutmeg, onion, oregano, paprika, parsley, peppercorns, red pepper, rosemary, saffron, sage, salt, sesame seed, tarragon, thyme, and turmeric.

After toppings are placed on the food product, Mixture 1e is returned to the oven at 400° Fahrenheit for an additional time of 5-10 minutes. This baking time is determined by the choice of toppings. For example, the additional baking time should allow for the melting of cheese onto food product surface. When the desired melting takes place, Mixture 1e and its toppings are ready for consumption.

Now, exemplary preparations of the food product according to the invention will be described. The exemplary embodiment is directed to a food product, as substitution of known pizza or focaccia dough, and includes 3 to 5 cups of riced and drained cauliflower, sized from 500-2500μ, at a weight of 3.7 oz per cup. This embodiment will utilize flaxseed as a primary protein source. The overall desired thicknesses can vary, from 1/16″ to ¼″ as needed to meet desired organoleptic properties.

The exemplary embodiment includes the following composition:

2.2 oz of brown rice flour;

0.9 oz of coconut flour;

0.75 oz of potato starch;

0.25 oz of flaxseed;

0.05 oz of active yeast;

3.75 oz of warm water; and

11.10 oz cauliflower (3 cups) or 14.80 oz cauliflower (4 cups) or 18.50 oz cauliflower (5 cups).

When using 3 cups cauliflower, total weight of the food product composition is 19.00 oz. Therefore, the weight percentage (wt %) of each ingredient in relation to the food product composition is as follows:

The brown rice flour would be about 11.58 wt %;

The coconut flour would be about 4.73 wt %;

The potato starch would be about 3.95 wt %;

The flaxseed would be about 1.31 wt %;

The active yeast would be about 0.28 wt %;

The water would be about 19.74 wt %; and

The cauliflower would be about 58.42 wt % of the total weight of the food product.

When using 4 cups cauliflower, total weight of the food product composition is 22.70 oz. Therefore, the weight percentage (wt %) of each ingredient in relation to an exemplary embodiment of the food product composition using 4 cups of cauliflower is as follows:

The brown rice flour would be about 9.69 wt %;

The coconut flour would be about 3.96 wt %;

The potato starch would be about 3.30 wt %;

The flaxseed would be about 1.10 wt %;

The active yeast would be about 0.23 wt %;

The water would be about 16.52 wt %; and

The cauliflower would be about 65.20 wt % of the total weight of the food product.

When using 5 cups cauliflower, total weight of the food product composition is 26.40 oz. Therefore, the weight percentage (wt %) of each ingredient in relation to an exemplary embodiment of the food product composition using 5 cups of cauliflower is as follows:

The brown rice flour would be about 8.40 wt %;

The coconut flour would be about 3.41 wt %;

The potato starch would be about 2.70 wt %;

The flaxseed would be about 0.95 wt %;

The active yeast would be about 0.18 wt %;

The water would be about 14.20 wt %; and

The cauliflower would be about 70.07 wt % of the total weight of the food product.

Alternative food product compositions for pizza dough embodiments can substitute ingredients already utilized within the aforementioned discussed exemplary embodiment. The need for substitution can vary due to ingredient availability, pricing, flavoring, or organolecptic concerns or for other unforeseen reasons. An example of this would consist of decreasing coconut flour in part or entirely and utilizing additional percentages of brown rice flour and potato starch. While this may alter the nutritional content slightly, the overall finished product would maintain the consistency in both flavor and texture as the exemplary embodiment.

In an alternative exemplary embodiment that eliminates coconut flour, the food product would have the following composition:

2.2 oz of brown rice flour;

1.50 oz of potato starch;

0.25 oz of flaxseed;

0.05 oz of active yeast;

3.75 oz of warm water; and

11.10 oz cauliflower (3 cups) or 14.80 oz cauliflower (4 cups) or 18.50 oz cauliflower (5 cups).

When using 3 cups cauliflower, total weight of the food product composition is 18.85 oz. Therefore, the weight percentage (wt %) of each ingredient in relation to the food product composition is as follows:

The brown rice flour would be about 11.67 wt %;

The potato starch would be about 7.96 wt %;

The flaxseed would be about 1.33 wt %;

The active yeast would be about 0.27 wt %;

The water would be about 19.89 wt %; and

The cauliflower would be about 58.88 wt % of the total weight of the food product.

When using 4 cups cauliflower, total weight of the food product composition is 22.55 oz. Therefore, the weight percentage (wt %) of each ingredient in relation to an exemplary embodiment of the food product composition using 4 cups of cauliflower is as follows:

The brown rice flour would be about 9.75 wt %;

The potato starch would be about 6.65 wt %;

The flaxseed would be about 1.11 wt %;

The active yeast would be about 0.23 wt %;

The water would be about 16.63 wt %; and

The cauliflower would be about 65.63 wt % of the total weight of the food product.

When using 5 cups cauliflower, total weight of the food product composition is 26.25 oz. Therefore, the weight percentage (wt %) of each ingredient in relation to an exemplary embodiment of the food product composition using 5 cups of cauliflower is as follows:

The brown rice flour would be about 8.38 wt %;

The potato starch would be about 5.71 wt %;

The flaxseed would be about 0.95 wt %;

The active yeast would be about 0.20 wt %;

The water would be about 14.28 wt %; and

The cauliflower would be about 70.48 wt % of the total weight of the food product.

In yet another exemplary embodiment of the invention, the food product composition can substitute or add additional ingredients not previously used within the exemplary embodiments described above. For instance, the food product may include eggs or egg whites, in place of or in addition to flaxseed, as a protein source. Flour and meal alternatives include but are not limited to; almond, amaranth, barley, buckwheat, corn, khorasan, millet, quinoa, rice, sorghum, soy, spelt, tapioca, teff, or wheat in place of or in addition to brown rice flour, coconut flour, and/or potato starch. These additional ingredients may alter the overall nutritional content, flavor and organoleptic properties but maintain the overall volume of cauliflower as a weight percentage within an alternative embodiment of the invention.

In an yet another exemplary embodiment of the invention the food product includes one (1) cup of wheat flour or barley flour in exchange for brown rice flour, coconut flour, and/or potato starch to varying degrees based on the desired nutritional, textural and/or flavorful outcome.

In an alternative exemplary embodiment that uses one cup of wheat flour in the the dry mix, the food product would have the following composition:

5.3 oz of wheat/barley flour;

0.9 oz of coconut flour;

0.25 oz of flaxseed;

0.05 oz of active yeast;

3.75 oz of warm water; and

11.10 oz cauliflower (3 cups) or 14.80 oz cauliflower (4 cups) or 18.50 oz cauliflower (5 cups).

When using 3 cups cauliflower, total weight of the food product composition is 21.35 oz. Therefore, the weight percentage (wt %) of each ingredient in relation to the food product composition is as follows:

The wheat/barley flour would be about 24.80 wt %;

The coconut flour would be about 4.22 wt %;

The flaxseed would be about 1.17 wt %;

The active yeast would be about 0.24 wt %;

The water would be about 17.56 wt %; and

The cauliflower would be about 51.99 wt % of the total weight of the food product.

When using 4 cups cauliflower, total weight of the food product composition is 25.05 oz. Therefore, the weight percentage (wt %) of each ingredient in relation to an exemplary embodiment of the food product composition using 4 cups of cauliflower is as follows:

The wheat/barley flour would be about 21.16 wt %;

The coconut flour would be about 3.59 wt %;

The flaxseed would be about 1.00 wt %;

The active yeast would be about 0.20 wt %;

The water would be about 14.97 wt %; and

The cauliflower would be about 59.08 wt % of the total weight of the food product.

When using 5 cups cauliflower, total weight of the food product composition is 28.75 oz. Therefore, the weight percentage (wt %) of each ingredient in relation to an exemplary embodiment of the food product composition using 5 cups of cauliflower is as follows:

The wheat/barley flour would be about 18.43 wt %;

The coconut flour would be about 3.13 wt %;

The flaxseed would be about 0.87 wt %;

The active yeast would be about 0.18 wt %;

The water would be about 13.04 wt %; and

The cauliflower would be about 64.35 wt % of the total weight of the food product.

In an yet another exemplary embodiment of the invention the food product includes one (1) egg in exchange for flaxseed to achieve the desired nutritional, textural, and/or flavorful outcome.

In an alternative exemplary embodiment that uses one (1) egg for flax seed as a protein source, the food product would have the following composition:

2.2 oz of brown rice flour;

0.9 oz of coconut flour;

0.75 oz of potato starch;

1.75 oz of egg;

0.05 oz of active yeast;

3.75 oz of warm water; and

14.80 oz cauliflower (4 cups) or 18.50 oz cauliflower (5 cups).

When using 4 cups cauliflower, total weight of the food product composition is 24.20 oz. Therefore, the weight percentage (wt %) of each ingredient in relation to an exemplary embodiment of the food product composition using 4 cups of cauliflower is as follows:

The brown rice flour would be about 9.10 wt %;

The coconut flour would be about 3.71 wt %;

The potato starch would be about 3.10 wt %;

The egg would be about 7.23 wt %;

The active yeast would be about 0.20 wt %;

The water would be about 15.49 wt %; and

The cauliflower would be about 61.15 wt % of the total weight of the food product.

When using 5 cups cauliflower, total weight of the food product composition is 27.9 oz. Therefore, the weight percentage (wt %) of each ingredient in relation to an exemplary embodiment of the food product composition using 5 cups of cauliflower is as follows:

The brown rice flour would be about 7.89 wt %;

The coconut flour would be about 3.23 wt %;

The potato starch would be about 2.69 wt %;

The egg would be about 6.27 wt %;

The active yeast would be about 0.18 wt %;

The water would be about 13.44 wt %; and

The cauliflower would be about 66.30 wt % of the total weight of the food product.

Now, yet another exemplary preparations of the food product according to the invention will be described. This exemplary embodiment is directed to a food product, as substitution a known chip, cracker, or flat bread dough, and includes 3 to 5 cups of undrained, larger and chunkier size of cauliflower, sized from 500-1400μ, at a weight of 4.0 oz per cup. This embodiment will utilize flaxseed as a primary protein source.

The exemplary embodiment includes the following composition:

2.2 oz of brown rice flour;

0.9 oz of coconut flour;

0.75 oz of potato starch;

0.25 oz of flaxseed;

0.05 oz of active yeast;

3.75 oz of warm water; and

12.00 oz cauliflower (3 cups) or 16.00 oz cauliflower (4 cups) or 20.00 oz cauliflower (5 cups).

When using 3 cups cauliflower, total weight of the food product composition is 19.90 oz. Therefore, the weight percentage (wt %) of each ingredient in relation to the food product composition is as follows:

The brown rice flour would be about 11.06 wt %;

The coconut flour would be about 4.52 wt %;

The potato starch would be about 3.77 wt %;

The flaxseed would be about 1.26 wt %;

The active yeast would be about 0.25 wt %;

The water would be about 18.84 wt %; and

The cauliflower would be about 60.30 wt % of the total weight of the food product.

When using 4 cups cauliflower, total weight of the food product composition is 23.9 oz. Therefore, the weight percentage (wt %) of each ingredient in relation to an exemplary embodiment of the food product composition using 4 cups of cauliflower is as follows:

The brown rice flour would be about 9.21 wt %;

The coconut flour would be about 3.77 wt %;

The potato starch would be about 3.14 wt %;

The flaxseed would be about 1.05 wt %;

The active yeast would be about 0.2 wt %;

The water would be about 15.69 wt %; and

The cauliflower would be about 66.94 wt % of the total weight of the food product.

When using 5 cups cauliflower, total weight of the food product composition is 27.9 oz. Therefore, the weight percentage (wt %) of each ingredient in relation to an exemplary embodiment of the food product composition using 5 cups of cauliflower is as follows:

The brown rice flour would be about 7.88 wt %;

The coconut flour would be about 3.23 wt %;

The potato starch would be about 2.68 wt %;

The flaxseed would be about 0.90 wt %;

The active yeast would be about 0.18 wt %;

The water would be about 13.45 wt %; and

The cauliflower would be about 71.68 wt % of the total weight of the food product.

Alternative food product compositions for pizza dough embodiments can substitute ingredients already utilized within the aforementioned discussed exemplary embodiment. The need for substitution can vary due to ingredient availability, pricing, flavoring, or organolecptic concerns or for other unforeseen reasons. An example of this would consist of decreasing coconut flour in part or entirely and utilizing additional percentages of brown rice flour and potato starch. While this may alter the nutritional content slightly, the overall finished product would maintain the consistency in both flavor and texture as the exemplary embodiment.

In an alternative exemplary embodiment that eliminates coconut flour, the food product would have the following composition:

2.2 oz of brown rice flour;

1.50 oz of potato starch;

0.25 oz of flaxseed;

0.05 oz of active yeast;

3.75 oz of warm water; and

12.00 oz cauliflower (3 cups) or 16.00 oz cauliflower (4 cups) or 20.00 oz cauliflower (5 cups).

When using 3 cups cauliflower, total weight of the food product composition is 19.75 oz. Therefore, the weight percentage (wt %) of each ingredient in relation to the food product composition is as follows:

The brown rice flour would be about 11.14 wt %;

The potato starch would be about 7.59 wt %;

The flaxseed would be about 1.27 wt %;

The active yeast would be about 0.26 wt %;

The water would be about 18.99 wt %; and

The cauliflower would be about 60.75 wt % of the total weight of the food product.

When using 4 cups cauliflower, total weight of the food product composition is 23.75 oz. Therefore, the weight percentage (wt %) of each ingredient in relation to an exemplary embodiment of the food product composition using 4 cups of cauliflower is as follows:

The brown rice flour would be about 9.26 wt %;

The potato starch would be about 6.31 wt %;

The flaxseed would be about 1.05 wt %;

The active yeast would be about 0.21 wt %;

The water would be about 15.78 wt %; and

The cauliflower would be about 67.36 wt % of the total weight of the food product.

When using 5 cups cauliflower, total weight of the food product composition is 27.75 oz. Therefore, the weight percentage (wt %) of each ingredient in relation to an exemplary embodiment of the food product composition using 5 cups of cauliflower is as follows:

The brown rice flour would be about 7.92 wt %;

The potato starch would be about 5.40 wt %;

The flaxseed would be about 0.90 wt %;

The active yeast would be about 0.10 wt %;

The water would be about 13.52 wt %; and

The cauliflower would be about 72.07 wt % of the total weight of the food product.

In yet another exemplary embodiment of the invention, the food product composition can substitute or add additional ingredients not previously used within the exemplary embodiments described above. For instance, the food product may include eggs or egg whites, in place of or in addition to flaxseed, as a protein source. Flour and meal alternatives include but are not limited to; almond, amaranth, barley, buckwheat, corn, khorasan, millet, quinoa, rice, sorghum, soy, spelt, tapioca, teff, or wheat in place of or in addition to brown rice flour, coconut flour, and/or potato starch. These additional ingredients may alter the overall nutritional content, flavor and organoleptic properties but maintain the overall volume of cauliflower as a weight percentage within an alternative embodiment of the invention.

In an yet another exemplary embodiment of the invention the food product includes one (1) cup of wheat flour or barley flour in exchange for brown rice flour, coconut flour, and/or potato starch to varying degrees based on the desired nutritional, textural and/or flavorful outcome.

In an alternative exemplary embodiment that uses one cup of wheat flour in the the dry mix, the food product would have the following composition:

5.3 oz of wheat/barley flour;

0.9 oz of coconut flour;

0.25 oz of flaxseed;

0.05 oz of active yeast;

3.75 oz of warm water; and

12.00 oz cauliflower (3 cups) or 16.00 oz cauliflower (4 cups) or 20.00 oz cauliflower (5 cups).

When using 3 cups cauliflower, total weight of the food product composition is 22.25 oz. Therefore, the weight percentage (wt %) of each ingredient in relation to the food product composition is as follows:

The wheat/barley flour would be about 23.82 wt %;

The coconut flour would be about 4.05 wt %;

The flaxseed would be about 1.12 wt %;

The active yeast would be about 0.23 wt %;

The water would be about 16.85 wt %; and

The cauliflower would be about 53.93 wt % of the total weight of the food product.

When using 4 cups cauliflower, total weight of the food product composition is 26.25 oz. Therefore, the weight percentage (wt %) of each ingredient in relation to an exemplary embodiment of the food product composition using 4 cups of cauliflower is as follows:

The wheat/barley flour would be about 20.19 wt %;

The coconut flour would be about 3.42 wt %;

The flaxseed would be about 0.95 wt %;

The active yeast would be about 0.19 wt %;

The water would be about 14.29 wt %; and

The cauliflower would be about 60.95 wt % of the total weight of the food product.

When using 5 cups cauliflower, total weight of the food product composition is 30.25 oz. Therefore, the weight percentage (wt %) of each ingredient in relation to an exemplary embodiment of the food product composition using 5 cups of cauliflower is as follows:

The wheat/barley flour would be about 17.52 wt %;

The coconut flour would be about 2.97 wt %;

The flaxseed would be about 0.82 wt %;

The active yeast would be about 0.17 wt %;

The water would be about 12.40 wt %; and

The cauliflower would be about 66.12 wt % of the total weight of the food product.

In an yet another exemplary embodiment of the invention the food product includes one (1) egg in exchange for flaxseed to achieve the desired nutritional, textural, and/or flavorful outcome.

In an alternative exemplary embodiment that uses one (1) egg for flax seed as a protein source, the food product would have the following composition:

2.2 oz of brown rice flour;

0.9 oz of coconut flour;

0.75 oz of potato starch;

1.75 oz of egg;

0.05 oz of active yeast;

3.75 oz of warm water; and

12.00 oz cauliflower (3 cups), 16.00 oz cauliflower (4 cups) or 20.00 oz cauliflower (5 cups).

When using 3 cups cauliflower, total weight of the food product composition is 21.40 oz. Therefore, the weight percentage (wt %) of each ingredient in relation to an exemplary embodiment of the food product composition using 4 cups of cauliflower is as follows:

The brown rice flour would be about 10.28 wt %;

The coconut flour would be about 4.21 wt %;

The potato starch would be about 3.50 wt %;

The egg would be about 8.18 wt %;

The active yeast would be about 0.24 wt %;

The water would be about 17.52 wt %; and

The cauliflower would be about 56.07 wt % of the total weight of the food product.

When using 4 cups cauliflower, total weight of the food product composition is 25.40 oz. Therefore, the weight percentage (wt %) of each ingredient in relation to an exemplary embodiment of the food product composition using 4 cups of cauliflower is as follows:

The brown rice flour would be about 8.66 wt %;

The coconut flour would be about 3.54 wt %;

The potato starch would be about 2.96 wt %;

The egg would be about 6.89 wt %;

The active yeast would be about 0.20 wt %;

The water would be about 14.76 wt %; and

The cauliflower would be about 62.99 wt % of the total weight of the food product.

When using 5 cups cauliflower, total weight of the food product composition is 29.40 oz. Therefore, the weight percentage (wt %) of each ingredient in relation to an exemplary embodiment of the food product composition using 5 cups of cauliflower is as follows:

The brown rice flour would be about 7.48 wt %;

The coconut flour would be about 3.06 wt %;

The potato starch would be about 2.55 wt %;

The egg would be about 5.95 wt %;

The active yeast would be about 0.20 wt %;

The water would be about 14.76 wt %; and

The cauliflower would be about 62.99 wt % of the total weight of the food product.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Unless defined otherwise, all technical and scientific terms used herein have the same meaning as commonly understood by one of ordinary skill in the art to which this invention belongs. In case of conflict, the present application including the definitions will control. Also, unless otherwise required by context, singular terms shall include pluralities and plural terms shall include the singular. As used herein, the term “about” modifying the quantity of an ingredient or reactant of the invention employed refers to variation in the numerical quantity that can occur, for example, through typical measuring and liquid handling procedures used for making concentrates or solutions in the real world; through inadvertent error in these procedures; through differences in the manufacture, source, or purity of the ingredients employed to make the compositions or to carry out the methods; and the like. The term “about” also encompasses amounts that differ due to different equilibrium conditions for a composition resulting from a particular initial mixture. Whether or not modified by the term “about,” the claims include equivalents to the quantities. In one embodiment, the term “about” means within 10% of the reported numerical value, alternatively within 5% of the reported numerical value.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

1. A food product composition comprising:
a dry mix composition in an amount of from about 15.50 to about 30.00 weight percentage (wt %) of the food product composition and having a gluten free flour;
water in an amount of from about 16.00 to about 20.00 wt % of the food product composition;
a leavening agent in an amount from about 0.20 to about 0.30 wt % of the food product composition;
a protein source in an amount from about 0.50 to about 19.00 wt % of the food product composition;
a gluten free substitute in an amount from about 45.00 to about 72.00 wt % of the food product composition and having cauliflower; and
a remainder of the composition containing a balance of incidental ingredients in an amount that is about 2.00 wt % or less of the food product composition.

2. The food product composition of claim 1, wherein the gluten free flour consists of starches selected from a group consisting of brown rice flour, coconut flour, potato starch, tapioca starch, pea fiber, rice flour, xanthan gum, guar gum, and almond flour.

3. The food product composition of claim 2, wherein the dry mix is in an amount of from about 18.00 to about 21.00 weight percentage (wt %) of the food product composition.

4. The food product composition of claim 3, wherein the protein source is flax seed.

5. The food product composition of claim 4, wherein the flax seed is in an amount from about 0.50 to about 2.00 weight percentage (wt %) of the food product composition.

6. The food product composition of claim 5, wherein the cauliflower is in an amount of from about 55.00 to about 72.00 weight percentage (wt %) of the food product composition.

7. The food product composition of claim 6, wherein the water is in an amount of from about 14.00 to about 20.00 weight percentage (wt %) of the food product composition.

8. The food product composition of claim 7, wherein the leavening agent is in an amount of from about 0.18 to about 0.27 weight percentage (wt %) of the food product composition.

9. The food product composition of claim 8, wherein the dry mix includes brown rice flour in an amount of from about 8.00 to about 12.00 weight percentage (wt %) of the food product composition, coconut flour in an amount of from about 3.25 to about 5.00 weight percentage (wt %) of the food product composition, and potato starch in an amount of from about 2.50 to about 4.25 weight percentage (wt %) of the food product composition.

10. The food product composition of claim 8, wherein the dry mix includes brown rice flour in an amount of from about 8.00 to about 12.00 weight percentage (wt %) of the food product composition and potato starch in an amount of from about 5.00 to about 8.50 weight percentage (wt %) of the food product composition

11. The food product composition of claim 8, wherein the dry mix includes wheat flour in an amount of from about 18.00 to about 25.00 weight percentage (wt %) of the food product composition and coconut flour in an amount of from about 3.00 to about 4.50 weight percentage (wt %) of the food product composition.

12. The food product composition of claim 3, wherein the protein source is an egg product.

13. The food product composition of claim 12, wherein the egg product is in an amount from about 15.00 to about 19.00 weight percentage (wt %) of the food product composition.

14. The food product composition of claim 13, wherein the cauliflower is in an amount of from about 45.00 to about 70.00 weight percentage (wt %) of the food product composition.

15. The food product composition of claim 14, wherein the water is in an amount of from about 16.00 to about 18.50 weight percentage (wt %) of the food product composition.

16. The food product composition of claim 15, wherein the leavening agent is in an amount of from about 0.21 to about 0.25 weight percentage (wt %) of the food product composition.

17. The food product composition of claim 16, wherein the dry mix includes brown rice flour in an amount of from about 7.50 to about 9.50 weight percentage (wt %) of the food product composition, coconut flour in an amount of from about 3.00 to about 4.00 weight percentage (wt %) of the food product composition, and potato starch in an amount of from about 2.50 to about 3.5 weight percentage (wt %) of the food product composition.

18. The food product composition of claim 17, wherein the cauliflower is in an amount of from about 61.00 to about 67.00 weight percentage (wt %) of the food product composition.
